(19) United States
(12) Patent Application Publication
(10) Pub. No.: US 2008/0266403 A1
(43) Pub. Date: Oct. 30, 2008

(54) Universal printing method and universal printer driver module for printing out non-image file documents, and electronic device having the driver module

(76) Inventors: Shih-Ming Hsu, Taipei (TW); Wei-Hsiang Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/890,488

(22) Filed: Aug. 7, 2007

(30) Foreign Application Priority Data
Apr. 27, 2007 (TW) 096115025

(51) Int. Cl. H04N 5/225

(52) U.S. Cl. 348/207.2; 348/552; 358/1.13

(57) ABSTRACT

A universal printing method for printing out non-image file documents is executed by installing a universal printer driver on a smart phone or a PDA that supports PictBridge, and includes activating an application program and opening a non-image file document, converting the non-image file document into at least one image file through the driver and an OS rendering module, and finally transmitting the at least one image file to a printing device through PictBridge. The method permits conversion of multiple pages of non-image file documents that originally cannot be printed using PictBridge to image files for printing by a printing device supporting PictBridge.

### CROSS-REFERENCE TO RELATED APPLICATION

This application claims priority of Taiwanese Application No. 096115025, filed on Apr. 27, 2007.

### BACKGROUND OF THE INVENTION

1. Field of the Invention

The invention relates to a universal printing method, more particularly to a universal printing method for printing non-image file documents and applicable to portable electronic devices.

2. Description of the Related Art

With the popularity of digital cameras, demand for output of digital images has increased. At the early stage of digital image output, a computer and relevant software have to be used to read or even adjust an image file in a digital camera or memory card in order to print out the image. In recent years, in order to simplify digital image output from digital cameras, the Camera & Imaging Products Association (CIPA) has published an industry standard known as PictBridge. By connecting a digital camera supporting PictBridge to a printer that also supports PictBridge, digital pictures can be directly outputted. Output parameters (such as number of copies to be outputted and dimensions) may even be directly set in the digital camera without going through a computer.

As shown in FIG. 1, a portable electronic device 10, such as a smart phone or a personal digital assistant (PDA), which is equipped with a high-pixel resolution digital camera module 11 has also become quite popular under the trend of development of integrated electronic products. The portable electronic device 10 also has requirements for digital image output. Therefore, new generation products are designed to support PictBridge as well. To print out a picture, a user connects the portable electronic device 10 to a PictBridge supporting printer 15 using various means, such as universal serial bus (USB), Bluetooth, wireless communication, etc., and sends an image file 110 generated by the digital camera module 11 from an image captured thereby to the printer 15.

However, the aforesaid portable electronic device 10 also has functions of sending and receiving e-mail, browsing web pages, opening and even editing non-image file documents 120 in WORD, PDF, or PPT format, in addition to existing functions of making calls, notetaking, picture-taking, etc. Therefore, even though both the portable electronic device 10 and the printer 15 support PictBridge to facilitate printing of the image file 110, since PictBridge does not support document formats other than image files, when the user wants to print out the non-image file document 120 in WORD, PDF, PPT or HTML format stored in the portable electronic device 10, the user still needs to use a computer 13 and a relevant application program module 131 of the computer 13 to read the non-image file document 120 in order to print out the same. It is apparent that the portable electronic device 10, be it a smart phone or a personal digital assistant, is not very convenient n terms of output of the non-image file document 120.

### SUMMARY OF THE INVENTION

Therefore, one object of the present invention is to provide a universal printing method to allow a portable electronic device such as a smart phone or a personal digital assistant to directly print out a non-image file document.

Another object of the present invention is to provide a universal printer driver module that can enable a portable electronic device such as a smart phone or a personal digital assistant to directly print out non-image file documents.

Yet another object of the present invention is to provide a portable electronic device, such as a smart phone or a personal digital assistant, that car directly print out non-image file documents.

Accordingly, the universal printing method for printing out non-image file documents or the present invention is applied to a portable electronic device. The electronic device supports PictBridge, is installed with an application program for processing a non-image file document, and is connected to a PictBridge supporting printing device. The method includes the following steps:

(A) loading a universal printer driver module into the electronic device;

(B) activating the application program and opening the non-image file document through the application program;

(C) converting the non-image file document into at least one image file through the universal printer driver module; and

(D) transmitting the at least one image file to the printing device through PictBridge.

In another aspect, a portable electronic device according to this invention has an operating system installed therein, includes an application program module for processing a non-image file document, and is connected to a printing device having a PictBridge interface. The present invention is characterized in that the electronic device further includes a PictBridge interface and the universal printer driver module.

In yet another aspect, the universal printer driver module of this invention includes an instructing unit, a file converting unit, and a transmitting unit. The instructing unit is used to instruct a rendering module of the operating system to convert a non-image file document opened by the application program module into at least one meta-file. The file converting unit receives the at least one meta-file, and is used to convert the at least one meta-file into a corresponding number of image files. The transmitting unit is used to transmit the at least one image file to the printing device through a PictBridge interface.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate relevant components for printing out image/non-image file is documents from an electronic device, such as a smart phone or a PDA, according to the prior art;

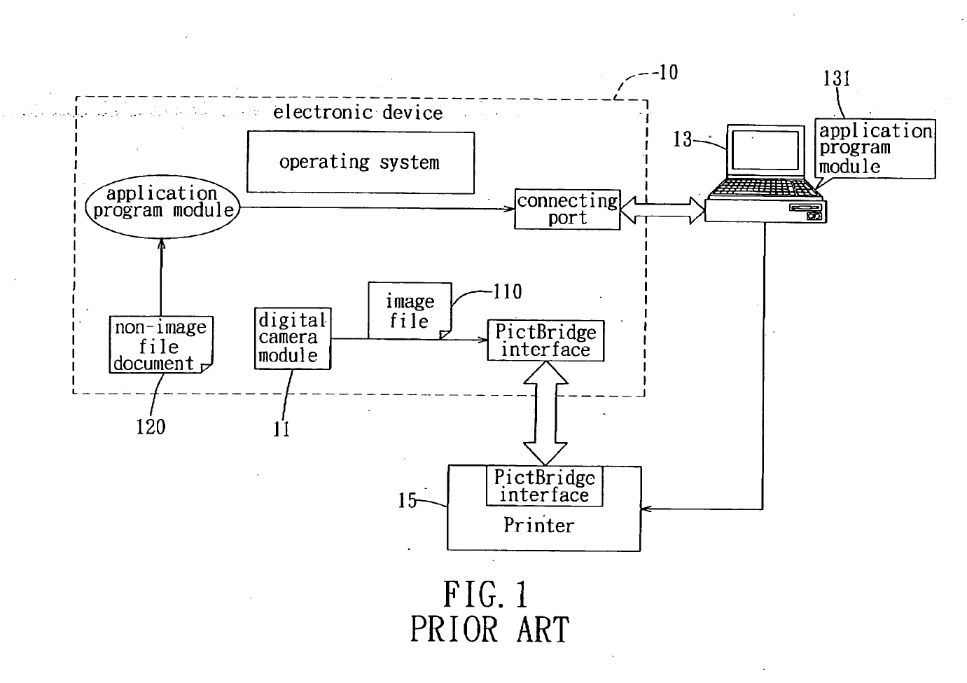

FIG. 2 is a schematic diagram to illustrate a preferred embodiment of a universal printing method for printing out non-image file documents according to the present invention;

FIG. 3 is a block diagram to illustrate relevant components for printing out image/non-image file documents from an electronic device, such as a smart phone or a PDA, according to the preferred embodiment.; and

FIG. 4 is a flowchart to illustrate the universal printing method of the preferred embodiment.

### DETAILED DESCRIPTION OF THE PREFERRED EMBODIMENT

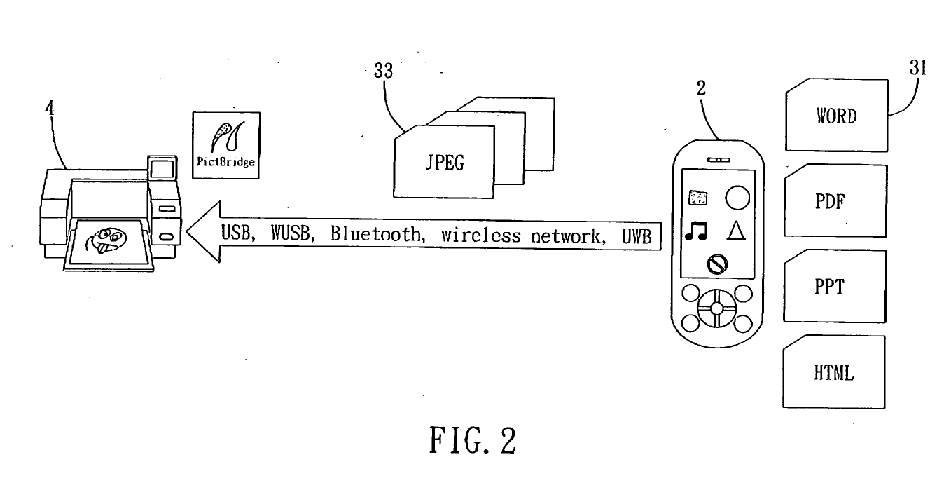

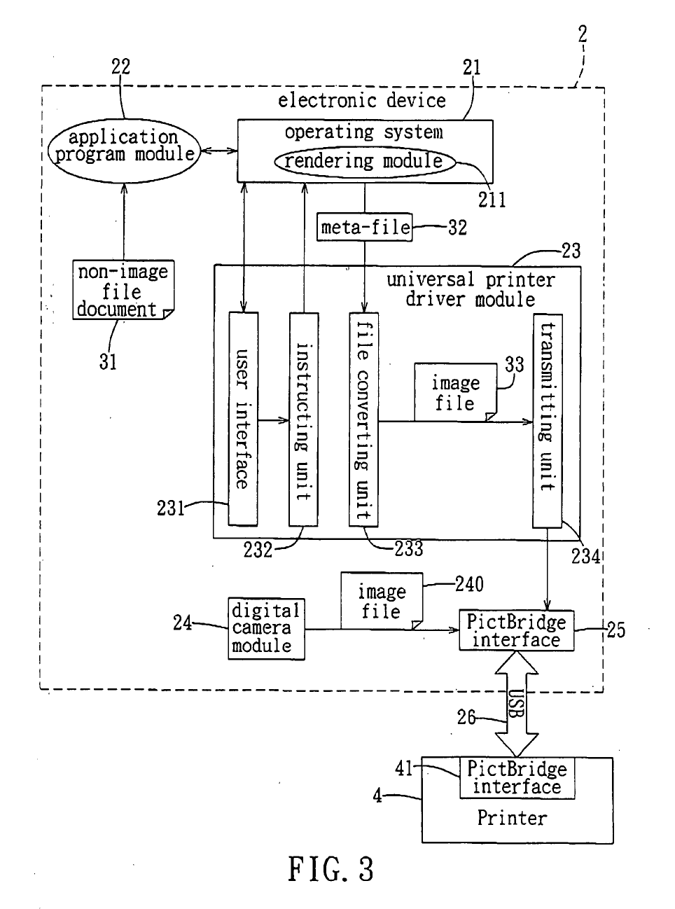

Referring to FIGS. 2 and 3, the preferred embodiment of a universal printing method for printing out non-image file documents according to the present invention is realized by downloading and installing a universal printer driver through a portable electronic device 2. The electronic device 2 may be a smart phone having multiple functions, a personal digital assistant, etc.

The electronic device 2 includes components (such as a housing, an input module such as a keyboard and pushbuttons, receiving/calling modules, a note-taking or contact list database, a display screen, etc.) required for maintaining basic requirements and basic functions thereof. However, the present invention should not be limited to specific basic components and structural relationships. Thus, the following description will not be directed to the basic components of the electronic device 2.

In addition to the basic components, the electronic device 2 has installed therein an operating system (OS) 21, and includes an application program module 22 for processing non-image file documents 31, a universal printer driver module 23, a digital camera module 24 capable of capturing an image to generate an image file 240 in JPEG format, a PictBridge interface 25 connected to the universal printer driver module 23 and the digital camera module 24, and a transmission interface. The transmission interface may be any wired or wireless transmission interface, such as universal serial bus (USB), wireless universal serial bus (WUSB), Bluetooth (BT), ultra-wide band (UWB), and Wi-Fi. The transmission interface of the electronic device 2 is exemplified to be a USB transmission interface 26 in this embodiment.

When the user wants to print out the image file 240 generated from the image captured by the digital camera module 24, since the electronic device 2 supports PictBridge, the electronic device 2 can be connected directly to a printing device 4 through a USB to print out a picture. The printing device 4 must be a printer or a multifunction office machine having a PictBridge interface 41 (i.e., PictBridge-supporting).

The application program module 22 is one generated from application programs, such as text editing software, electronic mail software, web page browsing software, etc., installed in the electronic device 2, for processing non-image file documents (such as WORD, PDF, PPD, HTML files) correspondingly produced using the software. In this embodiment, the application program module 22 is exemplified to be one for processing files produced using WORD text editing software. The application program module 22 may open and edit WORD documents, and may give printing instructions that include parameters such as pages to be printed, quality, etc.

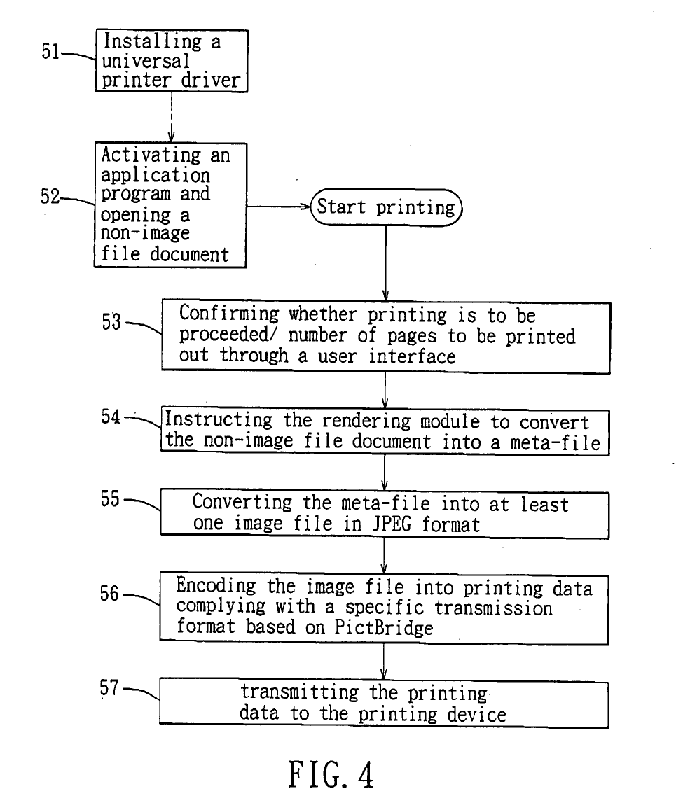

As shown in FIGS. 3 and 4, the electronic device 2 executes step 51 in advance. In step 51, a universal printer driver is installed by downloading through the Internet or by connecting to a computer, thereby generating the universal printer driver module 23. The universal printer driver module 23 includes a user interface 231, an instructing unit 232, a file converting unit 233, and a transmitting unit 234. The operating modes of the universal printer driver module 23 will be described with reference to the flowchart of FIG. 4.

As shown in FIG. 4, when the user executes step 52, the WORD application program is activated, a WORD document (i.e., the non-image file document 31) is opened, and a print command is given to the application program module 22. The flow then proceeds to the universal printing process, which includes the following steps 53 to 57.

In step 53, whether printing is to be proceeded and settings such as the number of pages to be printed out can be confirmed through the user interface 231.

In step 54, the instructing unit 232 instructs a rendering module 211 of the operating system 21 to convert the non-image file document 31 into at least one meta-file according to the number of pages to be printed out. For example, if the user wants to print out two pages of a multi-page WORD document, this step will be to convert the non-image file document 31 into two meta-files 32, so on and so forth.

In step 55, the file converting unit 233 receives the meta-file or meta-files 32, and converts the meta-file or meta-files 32 into a corresponding number of image files 33 in JPEG format. For example, if the two pages to be printed out have been converted into two meta-files 32 in step 54, the two meta-files 32 will be converted respectively to generate two image files 33 in this step.

In step 56, the transmitting unit 234 encodes the image files 33 into printing data complying with the USB transmission format based on PictBridge. Certainly, if the transmission interface of the electronic device 2 is of another type, such as WUSB, BT, UWB, or Wi-Fi, the image files 33 will be encoded in the corresponding transmission format in this step.

In step 57, the printing data is transmitted to the printing device 4 through USB.

In sum, by installing a newly developed universal printer driver in the electronic device 2, such as a smart phone, a PDA or the like, and by using the operating system 21, the electronic device 2 can be operated directly to convert non-image files in WORD, PDF, PPT, or HTML format, which originally cannot be printed out via PictBridge, into JPEG files so as to be printed out using the PictBridge-supporting printing device 4, thereby benefiting from the universality of PictBridge. Thus, even if a computer is not available or the user does not have a computer, non-image file documents can still be printed out conveniently, and the objects of the present invention can be achieved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A universal printing method for printing cut non-image file documents and to be applied to a portable electronic device, the electronic device supporting PictBridge, being installed with an application program for processing a non-image file document, and being connected to a PictBridge-supporting printing device, the universal printing method comprising the following steps:
(A) loading a universal printer driver module into the electronic device;
(B) activating the application program and opening the non-image file document through the application program;
(C) converting the non-image file document into at least one image file through the universal printer driver module; and
(D) transmitting the at least one image file to the printing device through PictBridge.

2. The universal printing method according to claim 1, wherein, step (C) includes a sub-step (C1) of instructing a rendering module of an existing operating system of the electronic device to convert the non-image file document into at least one meta-file according to a number of pages to be printed out, and a sub-step (C2) of converting the at least one meta-file into a corresponding number of the image files.

3. The universal printing method according to claim 2, wherein step (C) further includes, before the sub-step (C1), a sub-step (C0) of confirming whether printing is to be proceeded and the number of pages to be printed out through a user interface of the universal printer driver module.

4. The universal printing method according to claim 1, wherein, in step (C), the non-image file document is converted into the at least one image file in JPEG format.

5. The universal printing method according to claim 1, wherein step (D) includes a sub-step (D1) of encoding the at least one image file into printing data complying with a transmission format that is one of universal serial bus, wireless universal serial bus, Bluetooth, ultra-wide band, and Wi-Fi according to PictBridge, and a sub-step (D2) of transmitting the printing data to the printing device.

6. A universal printer driver module adapted for loading into a portable electronic device, the electronic device including a PictBridge interface and an application program module for processing a non-image file document, and being connected to a printing device including a PictBridge interface, said universal printer driver module comprising:
an instructing unit adapted to instruct a rendering module of an existing operating system of the electronic device to convert the non-image file document opened by the application program module into at least one meta-file according to a number of pages to be printed out;
a file converting unit for receiving the at least one meta-file and for converting the at least one meta-file into a corresponding number of image files; and
a transmitting unit adapted to transmit the at least one image file to the printing device through the PictBridge interface.

7. The universal printer driver module according to claim 6, wherein said transmitting unit encodes the at least one image file into printing data complying with a transmission format that is one of universal serial bus, wireless universal serial bus, Bluetooth, ultra-wide band, and Wi-Fi according to PictBridge, and is adapted to transmit the printing data to the printing device.

8. The universal printer driver module according to claim 6, further comprising a user interface adapted to be coupled to the rendering module of the operating system so as to confirm whether printing is to be proceeded and the number of pages to be printed out.

9. The universal printer driver module according to claim 6, wherein said file converting unit converts the at least one meta-file into the corresponding number of image files in JPEG format.

10. A portable electronic device adapted to be connected to a printing device, said portable electronic device comprising:
an operating system with a rendering module;
an application program module for processing a non-image file document;
a PictBridge interface; and
a universal printer driver module that includes:
an instructing unit for instructing said rendering module of said operating system to convert the non-image file document opened by said application program module into at least one meta-file according to a number of pages to be printed out;
a file converting unit for receiving the at least one meta-file and for converting the at least one meta-file into a corresponding number of image files; and
a transmitting unit adapted to transmit the at least one image file to the printing device through said PictBridge interface.

11. The portable electronic device according to claim 10, wherein said portable electronic device is a smart phone that further comprises a digital camera module connected to said PictBridge interface.

12. The portable electronic device according to claim 10, wherein said portable electronic device is a personal digital assistant that further comprises a digital camera module connected to said PictBridge interface.

13. The portable electronic device according to claim 10, further comprising a transmission interface complying with one of universal serial bus, wireless universal serial bus, Bluetooth, ultra-wide band, and Wi-Fi, and connected to said PictBridge interface.

14. The portable electronic device according to claim 10, wherein said application program module is used to process the non-image file document generated by one of text editing software, electronic mail software, and web page browsing software.

15. The portable electronic device according to claim 10, wherein said file converting unit of said universal printer driver module converts the at least one meta-file into the corresponding number of image files in JPEG format.
